(19) United States
(12) Patent Application Publication
(10) Pub. No.: US 2012/0268451 A1
(43) Pub. Date: Oct. 25, 2012

(54) THREE-DIMENSIONAL (3D) DISPLAY

(75) Inventors: Chao-Hsu Tsai, Hsinchu City (TW); Kuen Lee, Hsinchu City (TW); Chou-Lin Wu, Hsinchu City (TW)

(73) Assignee: INDUSTRIAL TECHNOLOGY RESEARCH INSTITUTE, Hsinchu (TW)

(21) Appl. No.: 13/276,324

(22) Filed: Oct. 19, 2011

Related U.S. Application Data
(63) Continuation-in-part of application No. 12/129,650, filed on May 29, 2008, now abandoned.

(30) Foreign Application Priority Data
Jun. 25, 2007 (TW) 96122925

(51) Int. Cl. G06T 15/00

(52) U.S. Cl. 345/419

(57) ABSTRACT

A 3D display has a light grating unit inserted between a polarized light module and an image display unit. The light grating unit includes a tristate switching unit, a microretarder unit, and a polarizing film. By controlling the tristate switching unit of the light grating unit to be switched between three modes, a displayed image is switched between a 2D image at the third mode and a 3D image at the first and second mode. The first mode and the second mode are the switching effect to exchange image for the left eye and the right eye. When the light grating unit switches fast, e.g. in 2 times or more of the video rate, and the content updates synchronously, viewers will see 3D images in full resolution.

### CROSS-REFERENCE TO RELATED APPLICATION

This application is a continuation-in-part of and claims the priority benefit of U.S. application Ser. No. 12/129,650, filed on May 29, 2008, now pending, which claims the priority benefit of Taiwan application serial no. 96122925, filed on Jun. 25, 2007. The entirety of each of the above-mentioned patent applications is hereby incorporated by reference herein and made a part of this specification.

### BACKGROUND

1. Technical Field

The disclosure relates to a three-dimensional (3D) display technology for being able to switch an image to be displayed in a two-dimensional (2D) image displaying mode or in a three-dimensional image displaying mode.

2. Description of Related Art

Related Art

FIG. 1 depicts a cross-sectional view in U.S. Pat. No. 725,567 in 1903. As illustrated in FIG. 1, a light provided by a backlight plate 100 is irradiated to a parallax barrier 101 which is constituted by alternately-arranged transparent and non-transparent vertical stripes. Thereby, the light in a stripe shape is irradiated at intervals. Thereby, since pixels of a transmission-type image display unit 102 correspond to human visual systems, a first image is then received by one human eye, whereas a second image is received by the other. This is a 3D autostereoscopic technology through which discrete 3D-images can be received by the left eye and the right eye of an observer, respectively. As shown in FIG. 1, only odd column pixels 01, 03, 05, 07 and 09 are received by the left eye, while even column pixels 02, 04, 06, 08 and 10 are merely received by the right eye. As such, the 3D images are constructed in the human visual system.

FIG. 2 illustrates another prior art whose structure differs from the structure depicted in FIG. 1. Namely, in FIG. 2, positions of the parallax barrier 101 and the transmission-type image display unit 102 are exchanged. As shown in FIG. 2, the transmission-type image display unit 102 is disposed between the backlight plate 100 and the parallax barrier 101, while the transmission-type image display unit 102, the backlight plate 100 and the parallax barrier 101 are disposed at the same side in FIG. 1. However, same effects can still be achieved according to the illustration in FIG. 2 as those accomplished based on the depiction in FIG. 1.

In still another prior art disclosed in U.S. Pat. No. 7,116,387, as shown in FIGS. 3A and 3B, two microretarder plates 2 and 3 respectively having a phase retardation of 0 and a half-wavelength phase retardation which are vertically interlaced are horizontally moved. The horizontal relative movement of the two microretarder plates 2 and 3 is able to switch between a state in which the parallax barrier exists and a state in which the parallax barrier does not exist. Thereby, the 2D images and the 3D images can be swapped over due to the horizontal movement of the microretarder plates and the incorporation of a polarizer. FIGS. 3A and 3B illustrate a transparent liquid crystal panel 1, two microretarder plates 2 and 3, a polarizer 4, a backlight module 5, two driving devices 6 and 7, and a carrier 8.

In FIG. 3A, a 2D image outputting mode is depicted. As phase retardation patterns of the two microretarder plates 2 and 3 are superposed with each other, the polarized lights can thoroughly penetrate the two microretarder plates 2 and 3, such that the 2D image may be displayed by the display unit 1. By contrast, FIG. 3B illustrates a 3D image outputting mode. When the phase retardations patterns of the two microretarder plates 2 and 3 are alternately arranged, the lights in the stripe shape are outputted at intervals since the two microretarder plates 2 and 3 respectively have the phase retardation of 0 and the phase retardation of λ/2. As such, the 3D image is displayed by the display unit 1, and it is likely to switch between the 2D image displaying mode and the 3D image displaying mode.

### SUMMARY

The disclosure is directed to a 3D display. The 3D display includes a polarized light module, a light grating unit, and an image display unit. The polarized light module outputs a polarized light. The light grating unit is disposed in a light path of the polarized light for modulating and outputting the polarized light in multiple stripe areas. Adjacent two of stripe areas are at a first polarization state and a second polarization state. The light grating unit has at least a first mode and a second mode. The first polarization state and the second polarization state are reversed when the light grating unit is switched between the first mode and the second mode. The image display unit receives the polarized light from the light grating unit and displays at least a first image and a second image respectively at first-set pixels and second-set pixels in the first mode, and displaying the first image and the second image respectively at the second-set pixels and the first-set pixels in the second mode.

The disclosure provides a dual-mode image display includes a polarized light module, an image display unit, a light grating unit. The polarized light module provides a light source in a polarizing state. The image display unit has a plurality of pixels for correspondingly displaying a 2D image or a 3D image. The light grating unit is disposed between the polarized light module and the image display unit. The light grating unit includes a tristate switching unit, having a first mode and second mode for correspondingly displaying the 3D image and a third mode for displaying the 2D image. A first part of the pixels is for displaying a left-eye image and a second part of the pixels is for displaying a right-eye image in the first mode. According to the switching state, the first part of the pixels is for displaying the right-eye image and the second part of the pixels is for displaying the left-eye image in the second mode.

Several exemplary embodiments accompanied with figures are described in detail below. It is to be understood that both the foregoing general description and the following detailed description are exemplary, and are intended to provide further explanation of the invention as claimed.

### BRIEF DESCRIPTION OF DRAWINGS

FIG. 1 is a schematic view illustrating a 3D display mechanism utilizing a conventional light grating.

FIG. 2 is a schematic view illustrating another conventional 3D display mechanism.

FIGS. 3A to 3B are schematic views illustrating still another conventional 3D image display which can be switched between a 2D image displaying mode and a 3D image displaying mode.

FIG. 4 is a schematic cross-sectional view illustrating a structure of a 3D display according to an exemplary embodiment of the disclosure.

FIGS. 5A through 5D are schematic views illustrating a displaying mechanism of the 3D display, according to an exemplary embodiment of the disclosure.

FIGS. 6A to 6E are schematic views illustrating an operating mechanism of the 3D display and a 2D image displaying mechanism under switching effect, according to an exemplary embodiment of the disclosure.

FIGS. 7 through 9 are schematic cross-sectional views illustrating the 3D display according to other exemplary embodiments of the disclosure.

FIGS. 10-12 are schematic cross-sectional views further illustrating the 3D display in applications with viewing zones, according to other exemplary embodiments of the disclosure.

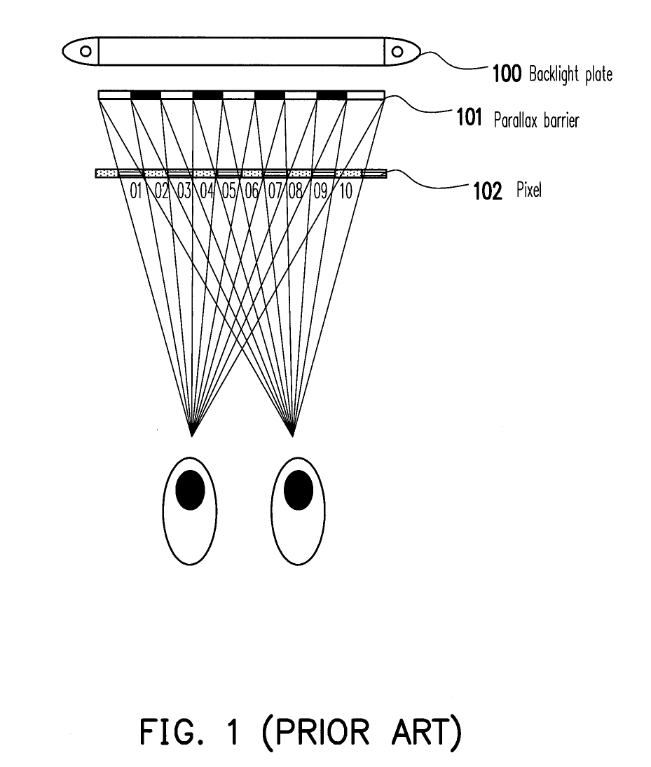

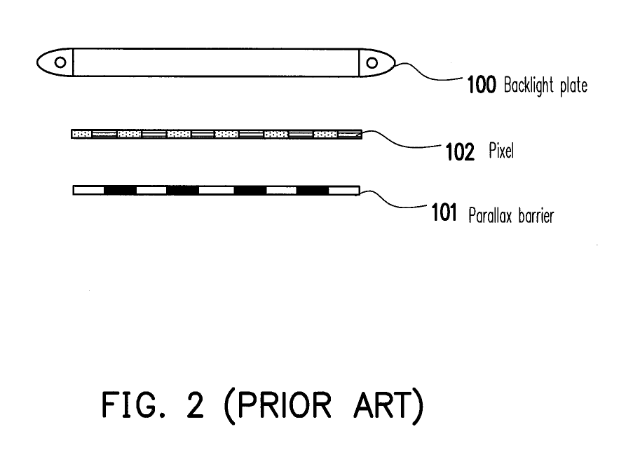

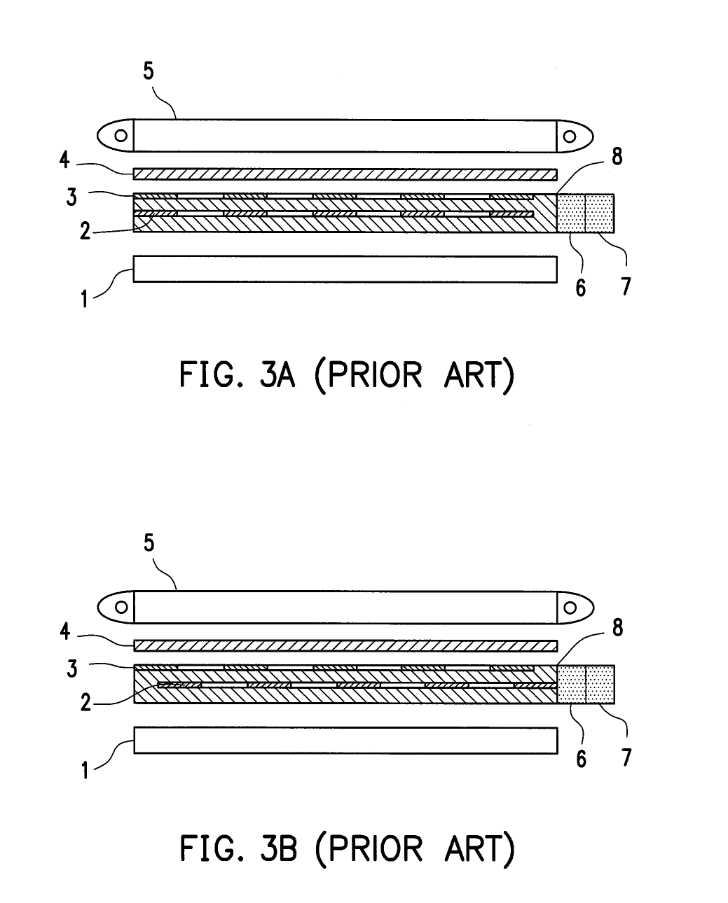

### DETAILED DESCRIPTION

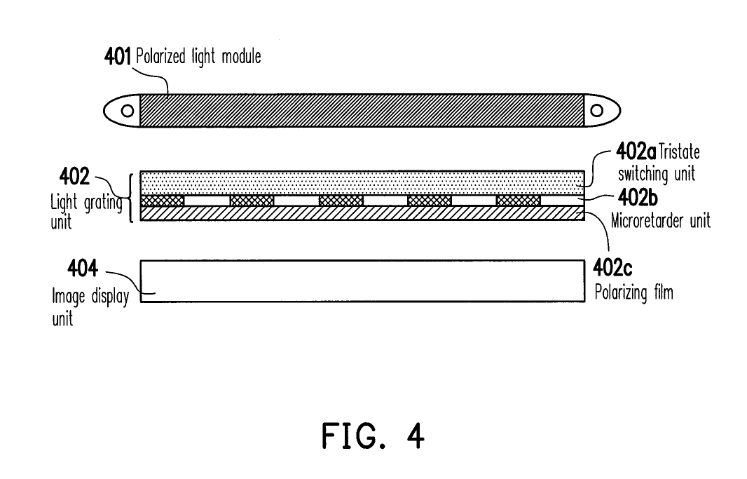

FIG. 4 is a schematic cross-sectional view illustrating a structure of a 3D display according to an exemplary embodiment of the disclosure. A polarized light module 401 provides a light source having the intended polarization state. Through a light grating unit 402, a polarized light in a stripe shape is outputted at intervals. Thereafter, an image display unit is employed to display a first image in one part of the display panel elements and a second image in another part of the display panel elements, and so on. The first image can be received by one eye of an observer, whereas the second image can be received by the other, and so on. A 3D image is then constructed. According to the present exemplary embodiment, the image display unit is, for example, a transmission-type image display unit 404. The light grating unit 402 includes a tristate switching unit 402a, a microretarder unit 402b, and a polarizing film 402c.

The tristate switching unit 402a is used as a polarization control unit to modulate the polarization of the polarized light emitted from the polarized light module. The tristate switching unit 402a can be at least switched into three modes, which cause the output light with polarization effects of no-change polarization state, 90°-rotated polarization state, and circular polarization state, respectively. As to be described later, the polarization effects of no-change polarization state and 90°-rotated polarization state can be used in 3D display. The polarization effect of circular polarization state allows the switch between 3D display and 2D display.

In general, the tristate switching unit 402a in the light grating unit 402 can have multiple modes. The material for the tristate switching unit 402a can be electrooptical materials, which have different optical properties when applied with different voltage. The electrooptical material has various choices. For one of the usual materials for the tristate switching unit 402a is liquid crystal. The liquid crystal unit can be controlled by the applied voltage to rotate the alignment of the liquid crystal molecules. For example, when a proper voltage is applied, the liquid crystal unit is at a circular polarization state. However, when a proper voltage is applied to cause the liquid crystal molecules being aligned to a state, then the liquid crystal unit is switched to a state so that the input polarized light can transmit without changing the polarization. However, when another proper voltage is applied to cause the liquid crystal molecules being aligned to another state, the input polarized light can transmit and change the polarization to be perpendicular to the input polarization state. For example, if the input polarized light has the polarization at 0 degree, then the output polarized light has the polarization state at 90 degrees. In other words, the electrooptical material can be controlled to have a first mode, a second mode, and a third mode. The first mode may be a state without changing the polarization state. The second mode may be the state with changing polarization state by 90 degrees. The third mode may be the state to change linear polarization into circular state. The tristate switching unit 402a can be referred to the polarization switching unit 402a, which can be controlled to have those three modes. However, when the function of 2D image display corresponding to the third mode is not used, the first mode and the second mode are used to switch. The effect is to keep tracking the left-eye image for viewing by left eye and the right-eye image for viewing by the right eye. The mechanism in better detail is to be described later.

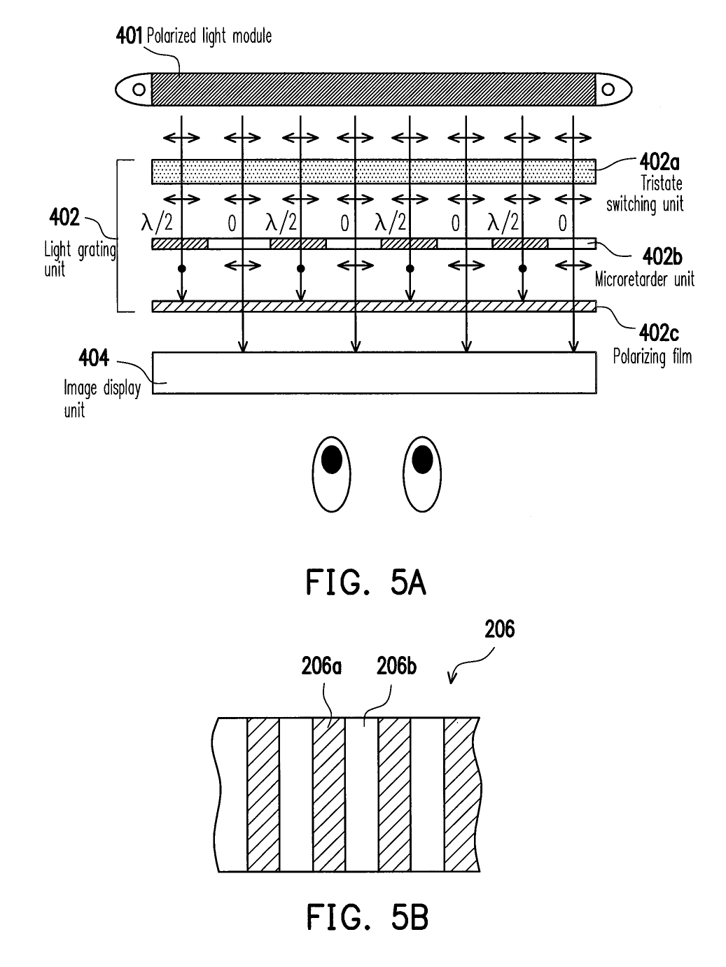

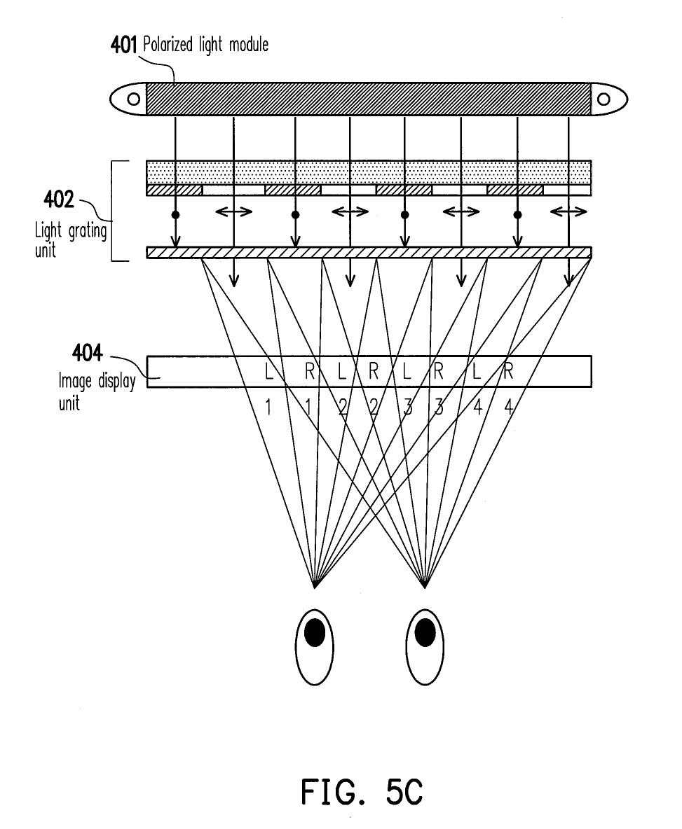

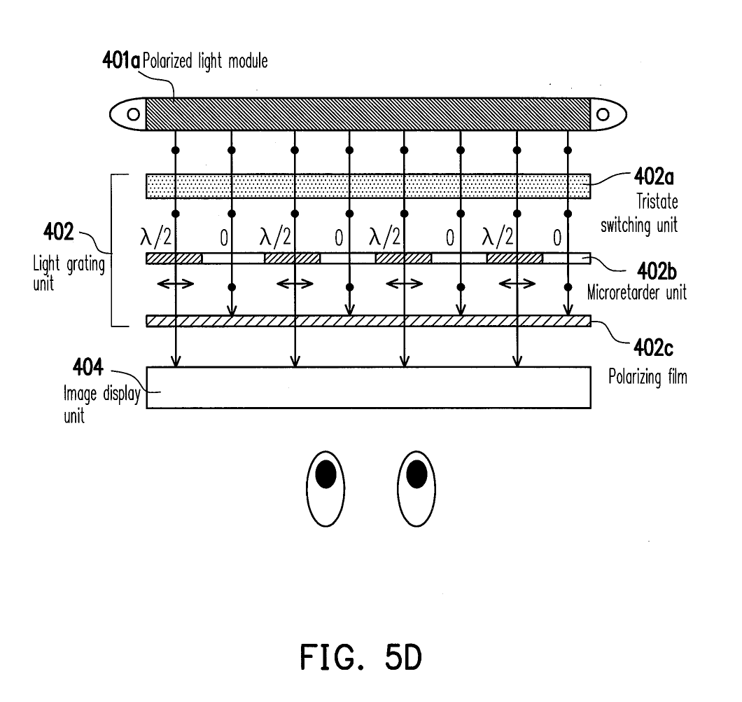

FIGS. 5A through 5D are schematic views illustrating a displaying mechanism of the 3D display, according to an exemplary embodiment of the disclosure. In FIG. 5A, a polarization direction of the polarized light generated by the polarized light module 401 is identical to a polarization direction of the polarized light of the polarizing film 402c. The polarized light generated by the polarized light module 401 is inputted into the light grating unit 402. Then, when the tristate switching unit 402a is switched for the 3D image displaying, the tristate switching unit 402a is controlled to be in the first mode or the second mode. In the first mod as an example, the polarization property of the inputted light is reserved, such as remaining at 0 degree, indicated by arrows. However in the second mod as an example, the polarization property of the inputted light is changed to another polarization state perpendicular to the input polarization state, such as 90 degrees. The mechanism is similar. In this exemplary embodiment, the first mode is used for describing the display effect.

When a direction of the polarized light generated by the polarized light module 401 is identical to a direction of the polarized light of the polarizing film 402c, and the polarized light produced by the polarized light module 401 passes through a stripe area having a phase retardation of λ/2 in the microretarder unit 402b, the polarization direction of the polarized light generated by the polarized light module 401 is rotated at 90 degrees. As such, a non-transparent area is formed. Simultaneously, as the polarized light passes through a stripe area having a phase retardation of 0, the polarized light having the same polarization direction is able to penetrate the polarizing film 402c, and thus a transparent area is formed.

FIG. 5B illustrates a microretarder unit 206 used in an exemplary embodiment of the disclosure. The microretarder unit 206 has a plurality of stripe-shaped first areas 206a and a plurality of stripe-shaped second areas 206b arranged in an interlaced fashion. For example, the first areas 206a have a phase retardation of λ/2, while the second areas 206b have a phase retardation of 0. The optical axis of the phase retardation is 45 degrees from the input polarization direction. It is likely to exchange the first areas 206a and the second areas 206b, which depends on actual demands. The polarized light passing through the first areas 206a is rotated at 90 degrees, such that the light passing through the first areas 206a and the second areas 206b have respective polarization states perpendicular to each other. Indeed, the phase retardation difference between the first areas 206a and the second areas 206b of the microretarder unit 206 should remain λ/2.

After passing through the stripe-shaped areas respectively having the phase retardation of 0 and the phase retardation of λ/2 in the microretarder unit 402b, the polarized lights in the same polarization direction are separated into two kinds of the polarized lights perpendicular to each other, and then the two kinds of the polarized lights are outputted with alternate distribution. Thereafter, through the polarizing film 402c, the polarized lights are filtered, such that stripe-shaped transparent and non-transparent lights are formed and outputted. Here, an array of opaque lines is formed by the light grating unit 402, and different sets of images shown by the image display unit 404 are then received by eyes of an observer, so as to construct a 3D image.

FIG. 5C depicts an imaging principle of the 3D image as shown in FIG. 5A. According to FIG. 5C, pixels L1, L2, L3 and L4 are received by the left eye of the observer, while pixels R1, R2, R3 and R4 are received by the right eye thereof, such the 3D image is established. Here, the description is the principle for one observer at a position. However, when multiple observers are viewing the image at the image display unit 404 or the observer is moving in observing the image display unit 404, for example, then several viewing zones can be setup. In other words, based on the light grating unit 402, it just needs two images, as the first image and the second image with a parallax, to enter two eyes of an observer. However, the image display unit 404 can accordingly display multiple images with different parallax for different viewing zones, so that the multiple images with respect to multiple view angles can be displayed. In the case of more than two views, the stripes of the microretarder are preferably to be oblique from the vertical direction to balance the horizontal and vertical resolutions. Here in FIG. 5C, the pixels L1, L2, L3, L4, . . . form one viewing zone image, the pixels R1, R2, R3, R4 . . . form another viewing zone image. Similarly, more viewing zone can be displayed. Actually, without specifying left L and right R, more viewing zone images can be displayed at the image display unit 404. Any two of the viewing zone images form the left image L and the right image R for one observer, so as to produce 3D effect. The exemplary embodiments in the disclosure just take left and right images for easy description.

FIG. 5D demonstrates another principle of operating the 3D display depicted in FIG. 4. As the direction of the polarized light generated by the polarized light module 401 is perpendicular to the direction of the polarized light of the polarizing film 402c, and the polarized light produced by the polarized light module 401 passes through the stripe area having the phase retardation of 0 in the microretarder unit 402b, the polarized light is not able to pass through the polarizing film 402c, and thus the non-transparent area is formed. Simultaneously, when the polarized light passes through the stripe area having the phase retardation of λ/2, the polarized light is rotated at 90 degrees and is able to penetrate the polarizing film 402c, leading to a formation of the transparent area. Other operating principles are similar to those presented by FIG. 5A.

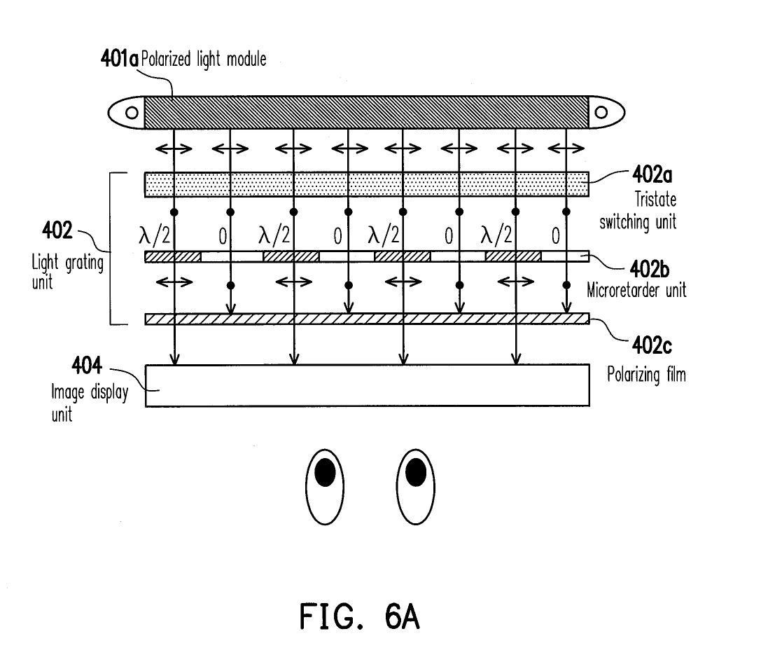

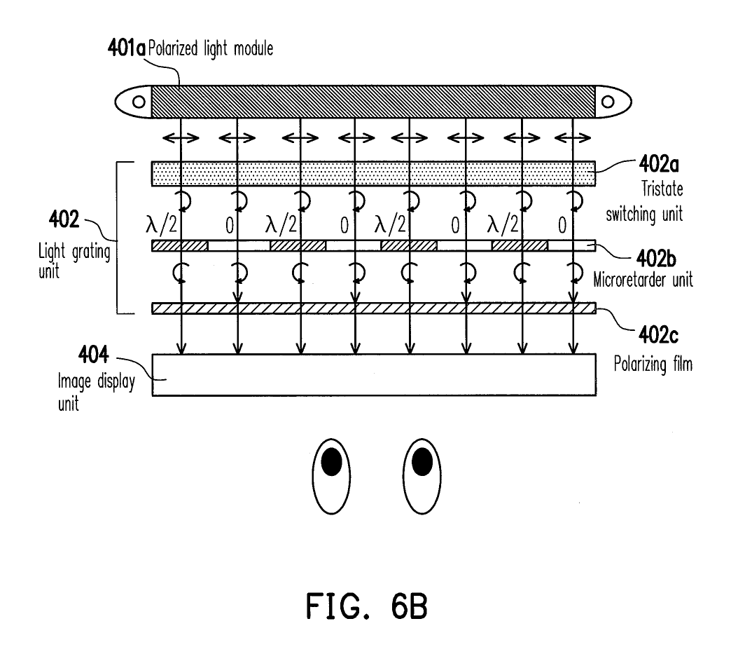

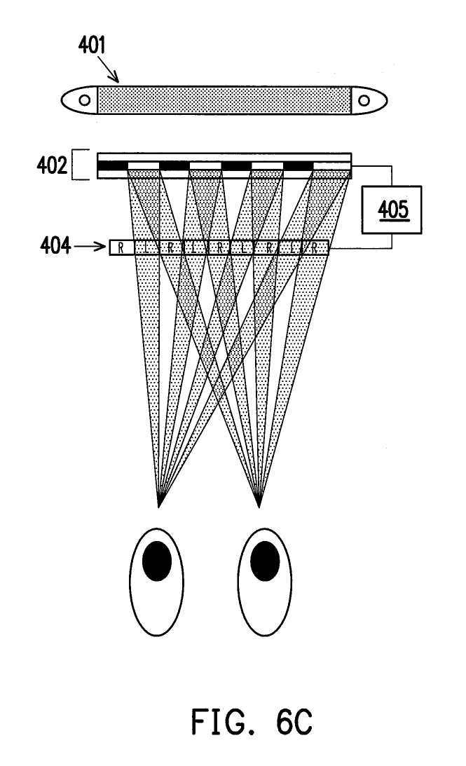

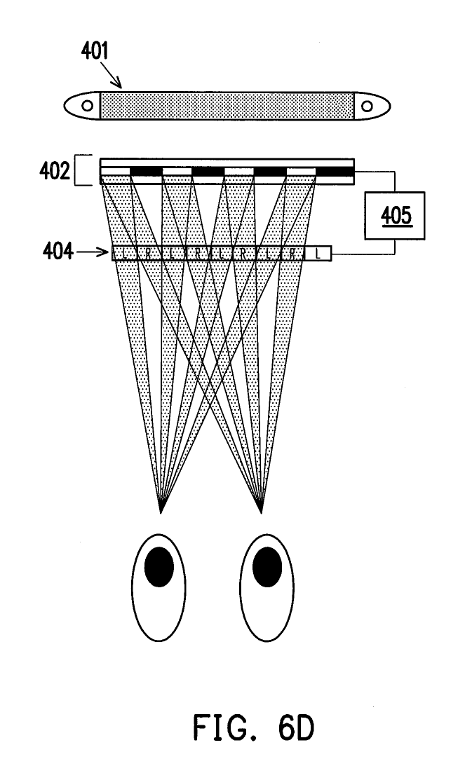

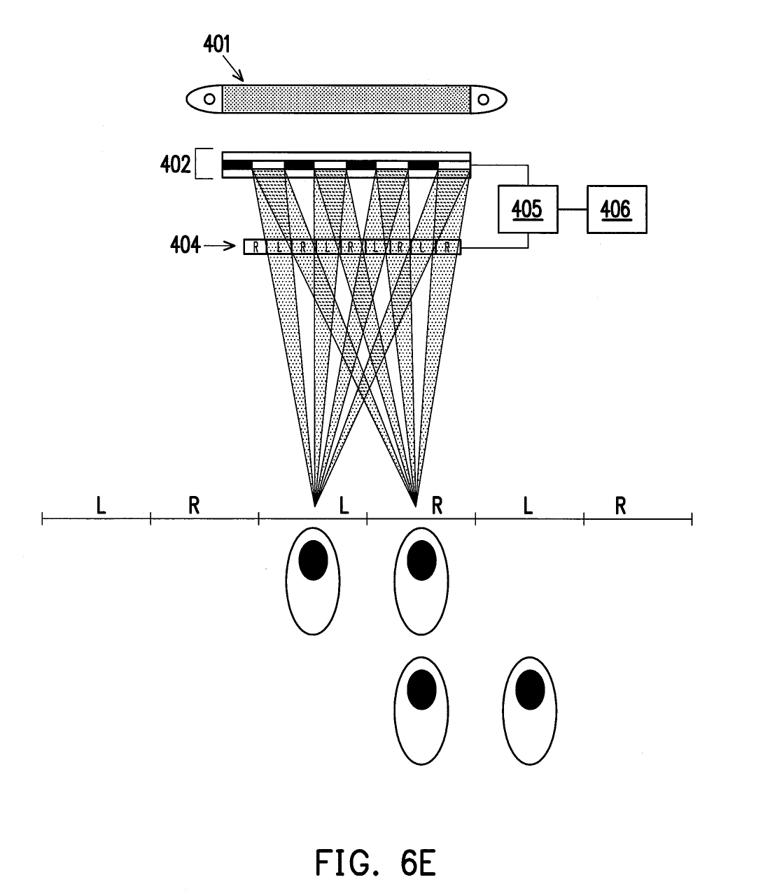

FIG. 6A-E are schematic views illustrating an operating mechanism of the 3D display and a 2D image displaying mechanism under switching effect, according to an exemplary embodiment of the disclosure.

In FIG. 6A, the tristate switching unit 402a is switched to the second mode. Then, the polarization state of the input polarized light is changed to another state, perpendicular to the input polarization state, as indicated by dots. In the second mode, the polarization state of the polarized light passing the 0 retardation area of the microretarder unit 402b remains. The polarization state of the polarized light passing the λ/2 retardation area of the microretarder unit 402b is rotated by 90 degrees. As a result, the adjacent two strip areas still have different linear polarization states, perpendicular to each other. However, in comparison with the polarization states in FIG. 5A, the polarization states are reversed. After the filtering effects by the polarizing film 402c, the parallax barrier for the light grating unit 402 is formed. However, the position of the barrier effect is exchanged in comparing with FIG. 5A.

Further in FIG. 6B, the light grating unit 402 is switched to the third mode. In other words, the tristate switching unit 402a is switched to the third mode and changes the input light into circular polarization state. The circular polarized light enters the microretarder unit 402b, in which the λ/2 retardation areas changes the circular polarization state in circular direction, being left-circular to right-circular or vice versa. The output polarized light still remains circular polarization. Since the circular polarized light have both linear polarization components at the 0 degree and 90 degrees, the lights at the λ/2 retardation areas and the 0 retardation areas can pass the polarizing film 402c. The barrier effect then disappears. This light in the third mode is suitable for use in 2D image display. The lights produced in the first mode and the second mode are used for 3D image display.

In order to switch between the three modes, synchronous control on the light grating unit 402 and the image display unit 404 should be set up. In FIG. 6C, a synchronous control unit 405 is used to control the light grating unit 402 and the image display unit 404. For example at the first mode, the light grating unit 402 produces the stripe lights, as indicated by the white stripes. The pixels in columns of the image display unit 404 are alternatively displaying the images for right eye and left eye.

In FIG. 6D, when the light grating unit 402 is switched to the second mode, the stripe lights from the light grating unit 402 is exchanged when comparing with FIG. 6C at the first mode. In other words, the white area in FIG. 6C is changed to dark area in FIG. 6D. Likewise, the dark area in FIG. 6C is changed to white area in FIG. 6D. In this situation, the viewing location or pixels of the image display unit 404 for the left eye and the right eye is shifted by one column in this example. In order to let the left eye and the right eye to view the same image, the image display unit 404 needs to synchronously change the display content. In this example, the pixels set for displaying the left-eye image (L) in FIG. 6C are now displaying the right-eye image (R) in FIG. 6D. The pixels set for displaying the right-eye image (R) in FIG. 6C are now displaying the left-eye image (L) in FIG. 6D. This switching can be controlled by the synchronous control unit 405. When the light grating unit switches fast, e.g. the switching rate between the first mode and the second mode is faster than a video rate by at least two times, and the content updates synchronously, viewers will see 3D images in full resolution.

In FIG. 6E, for the further application from FIG. 6C and FIG. 6D, when the observer may move in position, and the location of the left eye may shift to the region for displaying the right-eye image and the location of the right eye may shift to the region for displaying the left-eye image. The synchronous control unit 405 can switch between the first mode and the second mode. However, a viewing-eye monitor 406 can detect the location of the eyes. In order to detect the location of viewing eyes, the viewing-eye monitor 406 may includes an image fetching device, such as CCD device, to fetch the image, and an analyzing unit to analyze out the location of the eyes. Then, viewing-eye monitor 406 can inform the synchronous control unit 405 to switch to the proper mode.

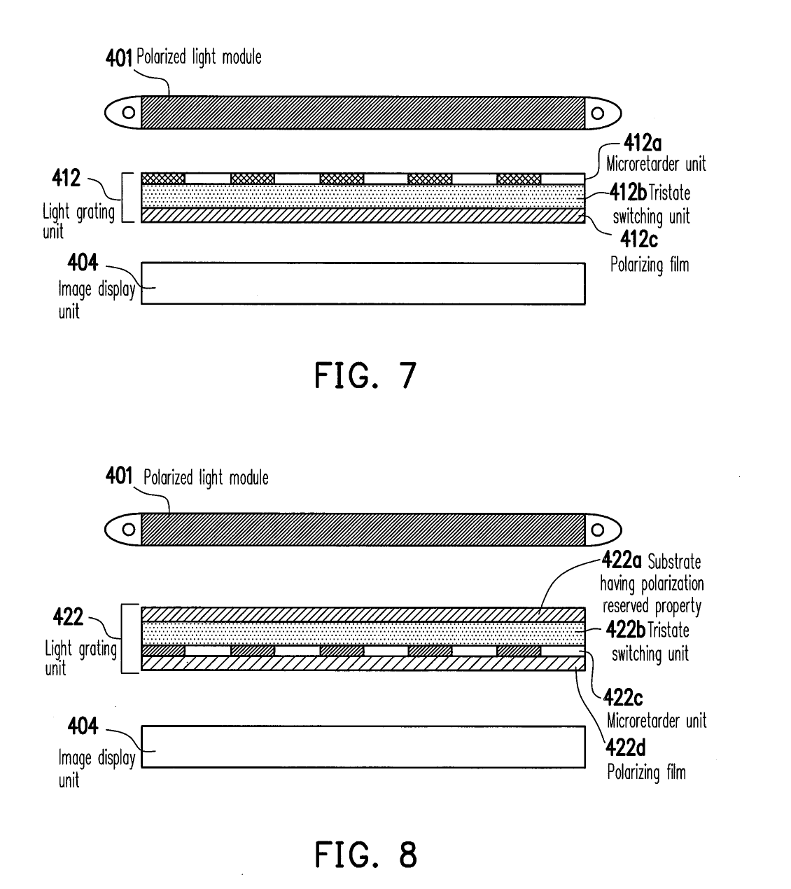

Further as illustrated in FIG. 7, a light grating unit 412 is constituted by stacking a microretarder unit 412a, a tristate switching unit 412b and a polarizing film 412c in sequence. The difference between FIG. 7 and FIG. 6A is that the tristate switching unit 412b of the light grating unit 412 is disposed between the microretarder unit 412a and the polarizing film 412c. The operating principles of the tristate switching unit 412b in the 2D image displaying mode and in the 3D image display mode are the same as the operating principles previously described in FIGS. 5 and 6.

The polarized lights generated by the polarized light module 401 are inputted into the light grating unit 412. Then, as the display is switched to the 3D image displaying mode, the polarized lights having the same polarities pass through the microretarder unit 412a and are separated into the polarized lights with two polarization states perpendicular to each other in different stripes area. Thereafter, when the polarized lights pass through the tristate switching unit 412b configured in the first mode, the polarization properties of the lights inputted into the microretarder unit 412a are reserved. Next, through the polarizing film 412c, the polarized lights are filtered, such that the parallax barriers having transparent and non-transparent vertical stripes are formed. As such, parts of the lights may respectively enter the left and the right eyes of the observer by means of the image display unit 404, so as to construct the 3D image according to the visual characteristics of human eyes.

The same polarized lights generated by the polarized light module 401 are inputted into the light grating unit 412. Then, as the light grating unit 412 is switched to the 2D image displaying mode, the polarized lights having the same polarities pass through the microretarder unit 412a and are separated into the polarized lights with the two polarization states perpendicular to each other. Thereafter, when the polarized lights pass through the tristate switching unit 412b configured in the third mode, the polarization properties of the lights inputted into the microretarder unit 412a are changed to circular polarization. Next, through the polarizing film 412c, the polarized lights are filtered and enter the eyes of the observer by means of the image display unit 404, so as to construct the 2D image.

FIG. 8 depicts still another exemplary embodiment of the disclosure. In FIG. 8, a light grating unit 422 includes a substrate 422a having the polarization reserved property, a tristate switching unit 422b, a microretarder unit 422c and a polarizing film 422d. The substrate 422a is, for example, made of glass, plastic, transparent plates, thin films, and so on. Here, FIG. 8 depicts a structure constituted by the substrate 422a having the polarization reserved property as the upper substrate, the microretarder unit 422c as the lower substrate, the tristate switching unit 422b sandwiched therebetween, and the polarizing film 422d.

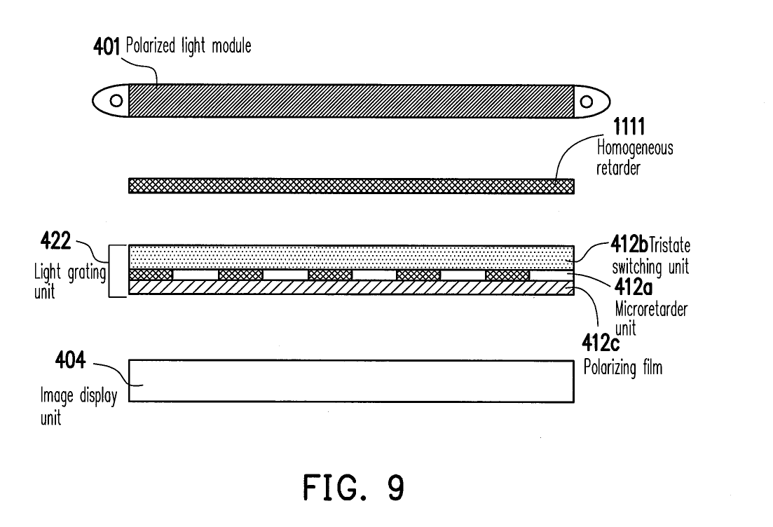

FIG. 9 illustrates a homogeneous retarder 1111 which is additionally disposed with a light emitting surface of the polarized light module 401. The homogeneous retarder 1111 has no patterns, and an optical axis direction of the homogeneous retarder 1111 is perpendicular to a optical axis direction of the microretarder unit 412a. As demonstrated in FIG. 5A, the non-transparent area of the parallax barrier corresponds to the λ/2 phase retardation area of the microretarder. Since the microretarder unit 412a cannot achieve the phase retardation of λ/2 at all wavelengths, light leakage may occur in partial. By contrast, in FIG. 5D, the non-transparent area of the parallax barrier corresponds to the phase retardation area of microretarder, and light leakage may still occur due to inevitable residue of phase retardation during the fabrication of the microretarder unit 412a. Based on the above, the homogeneous retarder 1111 including no patterns and having the optical axis direction perpendicular to the optical axis direction of the microretarder unit 412a is added to transform the non-transparent area of the parallax barrier in FIG. 5D into the area having the phase retardation of λ/2 in the microretarder unit 412a. After superposing the homogeneous retarder 1111 including no patterns with the area having the phase retardation of λ/2 in the microretarder unit 412a, a homogeneous area having no phase retardation is then constructed. Thereby, the drawback that the microretarder unit 412a cannot achieve the phase retardation of λ/2 at all wavelengths can be reduced, and light leakage arisen from the residue of phase retardation during the fabrication of the microretarder unit can be reduced as well. Here, “the perpendicular optical axis direction” is an ideal condition. However, since inaccuracy may occur during actual fabrication, the optical axis direction of the homogeneous retarder 1111 may be substantially perpendicular to that of the microretarder unit according to the disclosure.

In FIG. 9, the homogeneous retarder 1111 is disposed between the polarized light module 401 and the tristate switching unit 412b, yet the position of the homogeneous retarder 1111 is not limited in the disclosure. In other words, the homogeneous retarder 1111 may be disposed between the tristate switching unit 412b and the microretarder unit 412a, or disposed between the microretarder unit 412a and the polarizing film 412c.

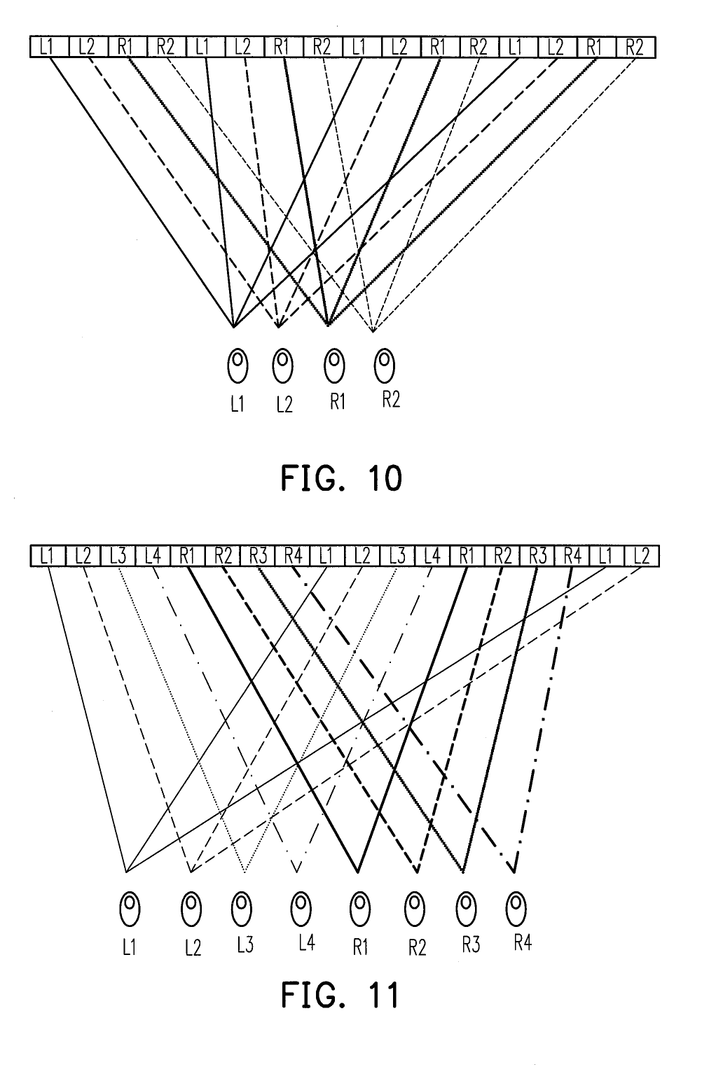

With the same design principle, the 3D image can be created in more applications with more viewing zones, allowing to have the 3D image at different positions and therefore allowing multiple observers to view the 3D image. Like the mechanism in FIG. 5C, more viewing zones can be created. FIGS. 10-12 are schematic cross-sectional views further illustrating the 3D display in applications with viewing zones, according to other exemplary embodiments of the disclosure. In FIG. 10, the image display unit 404, depending on resolutions, has multiple pixels. It can be arranged into more sets of pixels for more images. In this example, it is arranged into four sets of pixels, indicated as L1, L2, R1 and R2, in which “L” represent left eye and “R” represent right eye, for example. The pixels at L1 and R1 can form a 3D image. However, if the observer moves to the position at corresponding to pixels at L2 and R2, then the 3D image still remains. Alternatively, one observer views the 3D image at position of L1 and R1, and another observer can also view the different 3D image at position of L2 and R2.

Even further in FIG. 11, if the design is for more observers or more viewing zones, the 8 viewing zones are created, as the example. In this situation, one of arrangements is grouping into (L1, R1), (L2, R2), (L3, R3) and (L4, R4). In this situation, for example, four observers can view four different 3D images at different viewing position. Alternatively, any observer at the positions of (L1, R1), (L2, R2), (L3, R3) and (L4, R4) can see the 3D image.

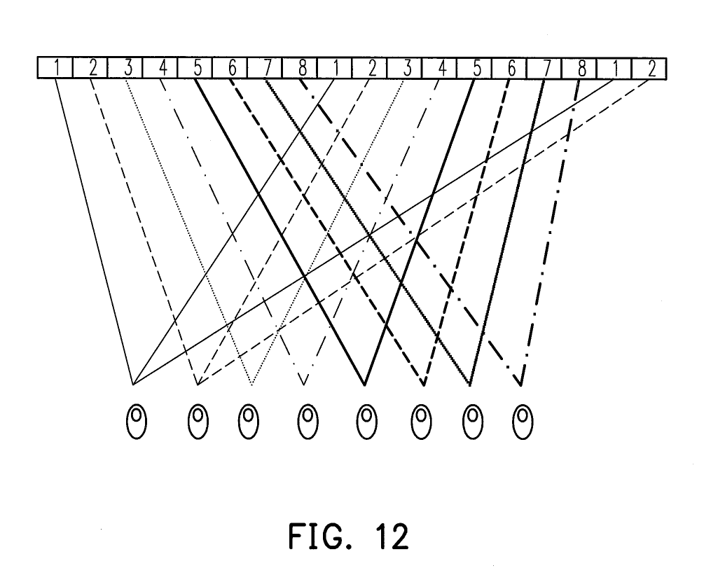

Even further in FIG. 12, based on the 3D display mechanism, it is not necessary to indicate to the right eye and left eye. Actually, any two eyes located at two different viewing zones, the 3D image can be created. In this exemplary embodiment, eight sets of column pixels are display, corresponding to eight viewing zones, without specifically assigned to left eye and right eye. The number of observers is also not limited to one. For example, four observers may view the 3D image at the same time. Actually in more general, it is not necessary to limit to eight sets of column pixels corresponding to eight viewing zones. The number of viewing zones is depending on the choice of intended resolution. It only needs to locate the positions of two eyes to simultaneously view any two different viewing zones, and then a 3D image can be created. This would also allow any observer to move to other positions. As a result, any observer can freely move.

In other words, the image display unit in associating with the light grating unit can output the polarized light as at least a first image displayed in first-set pixels and a second image displayed in second-set pixels. Optionally, more images at different viewing zones can be produced.

It will be apparent to those skilled in the art that various modifications and variations can be made to the disclosed exemplary embodiments. It is intended that the specification and examples be considered as exemplary only, with a true scope of the disclosure being indicated by the following claims and their equivalents.

What is claimed is:

1. A three-dimensional (3D) display, comprising:
a polarized light module, outputting a polarized light;
a light grating unit, disposed in a light path of the polarized light for modulating and outputting the polarized light in multiple stripe areas, wherein adjacent two of stripe areas are at a first polarization state and a second polarization state, wherein the light grating unit has at least a first mode and a second mode, the first polarization state and the second polarization state are reversed when the light grating unit is switched between the first mode and the second mode; and
an image display unit, receiving the polarized light from the light grating unit and displaying at least a first image and a second image respectively at first-set pixels and second-set pixels in the first mode, and displaying the first image and the second image respectively at the second-set pixels and the first-set pixels in the second mode.

2. The 3D display according to claim 1, wherein the image display unit outputs multiple images respectively displayed in multiple pixels sets corresponding to multiple viewing zones, wherein when two eyes of an observer simultaneously view two of the images at two of the viewing zones, a 3D image is created.

3. The 3D display according to claim 1, wherein the light grating unit comprises:
a polarization switching unit, to receive the polarized light from the polarized light module, wherein the polarization switching unit is switched between the first mode and the second mode, wherein a first polarization state of the polarized light in the first mode is perpendicular to a second polarization state of the polarized light in the second mode;
a microretarder unit, disposed with the polarization switching unit having a first phase modulation material and a second phase modulation material corresponding to the stripe areas and alternately arranged, wherein the first phase modulation material and the second phase modulation material respectively modulate a phase of the polarized light and output the modulated polarized light; and
a polarizing film allowing a passage of a designated polarized light.

4. The 3D display according to claim 3, wherein the polarization switching unit comprises an electrooptical material plate, which is controlled by an applied voltage to switch between the first mode and the second mode.

5. The 3D display according to claim 4, wherein the polarization switching unit is liquid crystal unit under controlled by the applied voltage.

6. The 3D display according to claim 1, further comprising:
a synchronizing control unit, to control the light grating unit and the image display unit to switch between the first mode and the second mode; and
a viewing-eye monitor, to detect a location of a pair of viewing eyes, and inform the synchronizing control unit to switch to the first mode or the second mode.

7. The 3D display according to claim 1, wherein a switching rate between the first mode and the second mode is faster at least two times than a video rate, and display contents of the first-set pixels and the second-set pixels are synchronously updated to have a full resolution for the 3D image.

8. A dual-mode image display, comprising:
a polarized light module for providing a light source in a polarizing state;
an image display unit, having a plurality of pixels for correspondingly displaying a 2D image or a 3D image; and
a light grating unit disposed between the polarized light module and the image display unit, wherein the light grating unit comprises a tristate switching unit, having a first mode and a second mode for correspondingly displaying the 3D image and a third mode for displaying the 2D image,
wherein a first part of the pixels is for displaying a left-eye image and a second part of the pixels is for displaying a right-eye image in the first mode, wherein the first part of the pixels is for displaying the right-eye image and the second part of the pixels is for displaying the left-eye image in the second mode.

9. The dual-mode image display according to claim 8, wherein the light grating unit is disposed in a light path of the polarized light for modulating and outputting the polarized light in multiple stripe areas at the first mode and the second mode, wherein adjacent two of stripe areas are at a first polarization state and a second polarization state, wherein the first polarization state and the second polarization state are reversed when the light grating unit is switched between the first mode and the second mode,
wherein the light grating unit changes the polarizing state into a circular polarized light at the third mode.

10. The dual-mode image display according to claim 9, wherein the image display unit outputs multiple images respectively displayed in multiple pixels sets corresponding to multiple viewing zones, wherein when two eyes of an observer simultaneously view two of the images at two of the viewing zones, the 3D image is created.

11. The dual-mode image display according to claim 9, wherein the light grating unit comprises:
a polarization switching unit serving as the tristate switching unit, to receive the polarized light from the polarized light module, wherein the polarization switching unit is switched between the first mode, the second and the third mode, wherein a first polarization state of the polarized light in the first mode is perpendicular to a second polarization state of the polarized light in the second mode, wherein the polarized light is changed to the circular polarized light at the third mode;
a microretarder unit, disposed with the polarization switching unit having a first phase modulation material and a second phase modulation material corresponding to the stripe areas and alternately arranged, wherein the first phase modulation material and the second phase modulation material respectively modulate a phase of the polarized light and output the modulated polarized light; and
a polarizing film allowing a passage of a designated polarized light.

12. The dual-mode image display according to claim 9, wherein the tristate switching unit comprises an electrooptical material plate, which is controlled by an applied voltage to switch between the first mode, the second mode and the third mode.

13. The dual-mode image display according to claim 9, wherein the polarization switching unit is a liquid crystal unit under controlled by the applied voltage.

14. The dual-mode image display according to claim 9, further comprising:
a synchronizing control unit, to control the light grating unit and the image display unit to switch between the first mode, the second mode and the third mode; and
a viewing-eye monitor, to detect a location of a pair of viewing eyes, and inform the synchronizing control unit to switch to the first mode or the second mode.

15. The dual-mode image display according to claim 9, wherein a switching rate between the first mode and the second mode is faster at least two times than a video rate, and display contents of the first part of the pixels and the second part of the pixels are synchronously updated to have a full resolution for the 3D image.
